(19) United States
(12) Patent Application Publication
(10) Pub. No.: US 2003/0160946 A1
(43) Pub. Date: Aug. 28, 2003

(54) ND filter, method for manufacturing said filter, and multi-display device and image forming device using said filter

(75) Inventor: Kazuya Yamanaka, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Optical Co., Ltd., Tokyo (JP)

(21) Appl. No.: 10/371,470

(22) Filed: Feb. 21, 2003

(30) Foreign Application Priority Data
Feb. 22, 2002 (JP) 2002-046745

(51) Int. Cl. G03B 21/26

(52) U.S. Cl. 353/30

(57) ABSTRACT

The present invention provides an ND filter manufacturing method which makes it possible to obtain an ND filter film that has light transmittance information in respective positions by exposing and imaging image electronic data that has light transmittance information for respective positions used to form an ND filter by employing an exposure imaging device that is capable of the direct exposure imaging of the image electronic data, and developing the film. Furthermore, the light transmittance distributions of ND filters disposed in positions corresponding to the overlapping regions in a multi-display device are constructed from curves, so that the overlapping regions are hard to distinguish from the non-overlapping regions.

This application claims benefit of Japanese Application No. 2002-046745 filed in Japan on Feb. 22, 2002, the contents of which are incorporated by this reference.

### BACKGROUND OF THE INVENTION

1. Field of the Invention

The present invention relates to an ND filter which is prepared using an apparatus that allows direct-exposure photography of image electronic data, a method for manufacturing this ND filter, and a multi-display device and image forming device using this ND filter.

2. Description of Related Art

ND filters (neutral density filters) are used in photographic systems such as cameras or the like, and are effective for performing photography in which the quantity of light is reduced without affecting the color, as in the case of photography performed under intense light or the like.

Common ND filters include filters in which a light absorbing pigment is mixed with a gelatin-acetate resin, and filters in which a thin film used to absorb light is formed on a glass substrate.

In such ND filter manufacturing methods, manufacture is easy in cases where the whole surface of a substrate is set at the same transmittance; however, manufacture is extremely difficult in case where it is necessary to vary the transmittance.

Accordingly, an ND filter manufacturing method of the type disclosed in Japanese Patent Application Laid-Open No. 5-173004 has been proposed as a method in which variations in transmittance are provided. In this patent, it is indicated that an original plate having an optical density distribution that has a specified relationship with an optical density distribution that provides an ND filtering action is prepared, this original plate is photographed at a reduced size by means of a camera, and the film subjected to a development processing is formed into an ND filter.

Meanwhile, a multi-display device is one application of the ND filter, which has a transmittance distribution of the type described above.

A multi-display device is a device which displays a single image on a screen using a plurality of image display devices constituting image projection units. Various devices of this type have been proposed in the past. In particular, for example, the devices disclosed in Japanese Patent Application Laid-Open No. 9-211386 and Japanese Patent Application Laid-Open No. 9-326981 have been proposed as devices in which the seams among projected images are smoothed out.

The multi-display devices disclosed in these patents are constructed such that the seam areas among images projected by a plurality of image display devices are caused to overlap with each other, and a light quantity adjusting means is provided so that the brightness in these overlapping areas is made uniform. An ND filter which has a transmittance distribution may be cited as one example of such light quantity adjusting means. Conventionally, in order to achieve a uniform brightness in this overlapping area, such a system has been constructed using filters which have light reducing characteristics that vary the entire regions of the overlapping portions of the respective image display devices more or less into a linear from the complete blocking of light to the complete transmission of light.

However, in the case of the abovementioned conventional ND filter manufacturing method, it is necessary to prepare an original plate that has an optical density distribution in order to obtain a transmittance distribution in the ND filter, so that it is impossible to handle shapes which are such that a physical model for the preparation of the original plate cannot be manufactured. Accordingly, the preparation of the original plate requires time and expense, and these problems must be solved.

Furthermore, in the case of ND filters used for large light quantities and ND filters used for polarized light, and in cases where the film that is used is converted into an ND filter by causing the film to sense light by exposure to light, there are such difficulties that the light resistance of the film must be increased, and that the polarized light must not be disturbed.

Moreover, in cases where a film that is caused to sense light by exposure to light is used as an ND filter, small irregularity is formed in the surface of the film by the emulsion, so that the transmitted light is scattered by this irregularity. Accordingly, in the case of such an ND filter, there is a greater possibility of a drop in transmittance and the generation of stray light due to scattering than in the case of an ND filter of the type in which a light absorbing pigment is mixed with a gelatin-acetate resin or an ND filter of the type in which a thin film is formed on a glass substrate used as a base, which currently exist as common ND filters, and thus these problems must be solved.

Furthermore, in multi-display devices, in cases where there is a mismatching or deviation in the light reduction characteristics and in the width of the overlapping portions obtained by the light quantity adjusting means in the prior art described above, the brightness of the overlapping portions differs from that of the non-overlapping portions, so that these overlapping portions might be easily distinguished. This problem must also be solved.

### SUMMARY OF THE INVENTION

A first object of the present invention is to provide an ND filter manufacturing method in which there is no need to prepare an original plate, in which complex transmittance distributions can also be handled, and in which the required preparation time is shorter.

A second object of the present invention is to provide an ND filter which can suppress a drop in the transmittance caused by small irregularity arising from the emulsion, and which can suppress the generation of stray light caused by scattering, in cases where the film that is used is converted into an ND filter by causing the film the sense light by exposure to light.

A third object of the present invention is to provide a multi-display device in which the overlapping portions are hard to be distinguished in cases where mismatching or deviation of the width of the overlapping portions occurs, or in which such mismatching or deviation of the width of the overlapping portions tends not to occur.

A fourth object of the present invention is to provide an image forming device which uses an improved ND filter.

In short, the present invention is an ND filter manufacturing method comprising the steps of performing exposure imaging on a photosensitive material on the basis of light transmittance information about respective positions used to construct an ND filter, and developing the abovementioned photosensitive material.

Furthermore, the present invention is an ND filter which is formed using a film that is subjected to a development processing, this film comprising a film layer in which the light transmittance differs according to the position, and a colorless transparent resin layer which has a thickness that makes it possible to fill small irregularity in the surface of said first film.

Furthermore, the present invention is a multi-display device comprising a plurality of image projection units, wherein a single image is formed as a whole by overlapping partial images projected onto a screen by the abovementioned image projection units so that there are overlapping regions at the peripheral edges in adjacent partial images, and a light quantity adjusting means which adjusts the light quantity of the luminous flux that is projected onto the abovementioned overlapping regions with respect to one peripheral edge of each of the abovementioned projected partial images so that the brightness of the abovementioned overlapping regions is caused to coincide substantially with the brightness of the partial images in areas other than the abovementioned overlapping regions, wherein the light transmittance is set such that the brightness distributions of the abovementioned overlapping regions are described by curves.

A multi-display device according to the present invention comprises: three or more image projection units, wherein a single image is formed as a whole by overlapping partial images projected onto a screen by the abovementioned image projection units so that there are overlapping regions at the peripheral edges in adjacent partial images; and a light quantity adjusting means which adjusts the light quantity of the luminous flux that is projected onto the abovementioned overlapping regions with respect to one peripheral edge of each of the abovementioned projected partial images so that the brightness of the abovementioned overlapping regions is caused to coincide substantially with the brightness of the partial images in areas other than the abovementioned overlapping regions, wherein there are overlapping regions on two or more sides, and the light quantity adjusting means is formed by two or more of transmittance distributions.

A multi-display device according to the present invention comprises a plurality of image projection units, wherein a single image is formed as a whole by overlapping partial images projected onto a screen by the abovementioned image projection units so that there are overlapping regions at the peripheral edges in adjacent partial images, and wherein the abovementioned multi-display device further comprises: an image pickup means for capturing the images projected onto the abovementioned screen; a brightness detecting means for detecting the shape and brightness of the abovementioned overlapping regions by extracting brightness signals from the image pickup signals of the abovementioned image pickup unit; a light quantity adjusting means which adjusts the light quantities of the luminous flux that is projected onto the abovementioned overlapping regions with respect to one peripheral edge of each of the abovementioned projected partial images so that the brightness of the abovementioned overlapping regions is caused to coincide substantially with the brightness of the partial images in areas other than the abovementioned overlapping regions; and an image calculating unit for performing calculations in order to adjust the light quantity to the optimal light quantity on the basis of the output of the abovementioned brightness detecting means, and for controlling the light quantity adjustment of the abovementioned light quantity adjusting means on the basis of the results of the abovementioned calculations.

An image forming device according to the present invention comprises: a lamp which serves as a light source; an image display element which forms an image; a projection optical system which is used to enlarge and project the image of the abovementioned image display element; and a light quantity adjusting means which is manufactured by an ND filter manufacturing method comprising the steps of performing exposure imaging on a photosensitive material on the basis of light transmittance information for respective positions used to construct an ND filter, and developing the abovementioned photosensitive material.

An image forming device according to the present invention comprises: a lamp which serves as a light source; an image display element which forms an image; a projection optical system which is used to enlarge and project the image of the abovementioned image display element; and a light quantity adjusting means constituted by an ND filter using a developed film that comprises a film layer in which the light transmittance differs in respective positions, and a colorless transparent resin layer which has a thickness that makes it possible to fill small irregularity in the surface of the abovementioned film.

The above and other objects, features and advantages of the invention will become more clearly understood from the following description referring to the accompanying drawings.

### BRIEF DESCRIPTION OF THE DRAWINGS

FIGS. 1 through 7B illustrate a first embodiment of the present invention;

FIG. 1 is a diagram showing an example of the manufacture of ND filter constituent part by means of image electronic data which has light transmittance information for respective positions used to construct an ND filter;

FIG. 2 is a graph which shows the numerical values constituting image electronic data on a line passing through A, B, C and D in FIG. 1;

FIG. 3 is a diagram showing an example of manufacture in which a plurality of ND filter constituent parts based on image electronic data prepared in FIG. 1 are formed on a film;

FIG. 4 is a flow chart which shows the processes from the preparation of the image electronic data to the completion of the filter manufacturing;

FIG. 5 is a graph which shows the target light transmittance on the film;

FIGS. 6A, 6B, 7A and 7B are graphs which illustrate the electronic data correction method used to obtain the target light transmittance;

FIGS. 8 through 11 illustrate a second embodiment of the present invention;

FIG. 8 is an enlarged sectional view which shows the film;

FIG. 9 is an enlarged sectional view which shows the film in a state in which a colorless transparent sheet has been bonded to the film;

FIG. 10 is an enlarged sectional view which shows the film in a state in which the film has been bonded to a polarizing plate on an LCD;

FIG. 11 is an enlarged sectional view which shows the film in a state in which AR-treated colorless transparent sheets have been bonded to the film;

FIGS. 12 through 17 illustrate a third embodiment of the present invention;

FIG. 12 is a diagram which shows the overall construction of a multi-display device;

FIGS. 13A and 13B are graphs which show how the light quantity adjusting means of the multi-display device in FIG. 12 is constructed such that there is a rectilinear light transmittance distribution, and which also show the brightness distributions of the corresponding overlapping regions;

FIGS. 14A and 14B are graphs which show how the light quantity adjusting means of the multi-display device in FIG. 12 is constructed such that there is a parabolic light transmittance distribution, and which also show the brightness distributions of the corresponding overlapping regions;

FIGS. 15A and 15B are graphs which show how the light quantity adjusting means of the multi-display device in FIG. 12 is constructed such that there is a light transmittance distribution consisting of a circular arc and a tangent, and which also show the brightness distributions of the corresponding overlapping regions;

FIGS. 16A and 16B are graphs which show how the light quantity adjusting means of the multi-display device in FIG. 12 is constructed such that there is a sine-waveform light transmittance distribution, and which also show the brightness distributions of the corresponding overlapping regions; and

FIG. 17 is a diagram which shows an optimizing system for the light quantity adjusting means in the multi-display device.

### DETAILED DESCRIPTION OF PREFERRED EMBODIMENT(S)

Preferred embodiments of the present invention will be described below with reference to the attached figures.

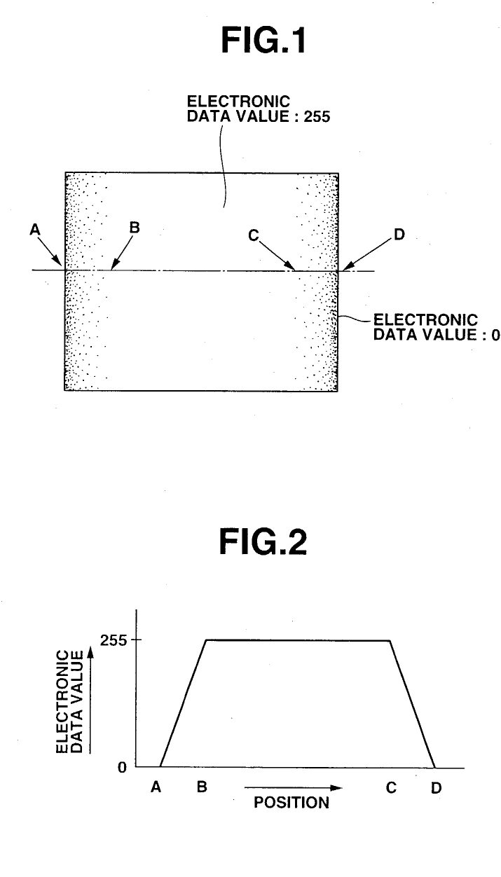

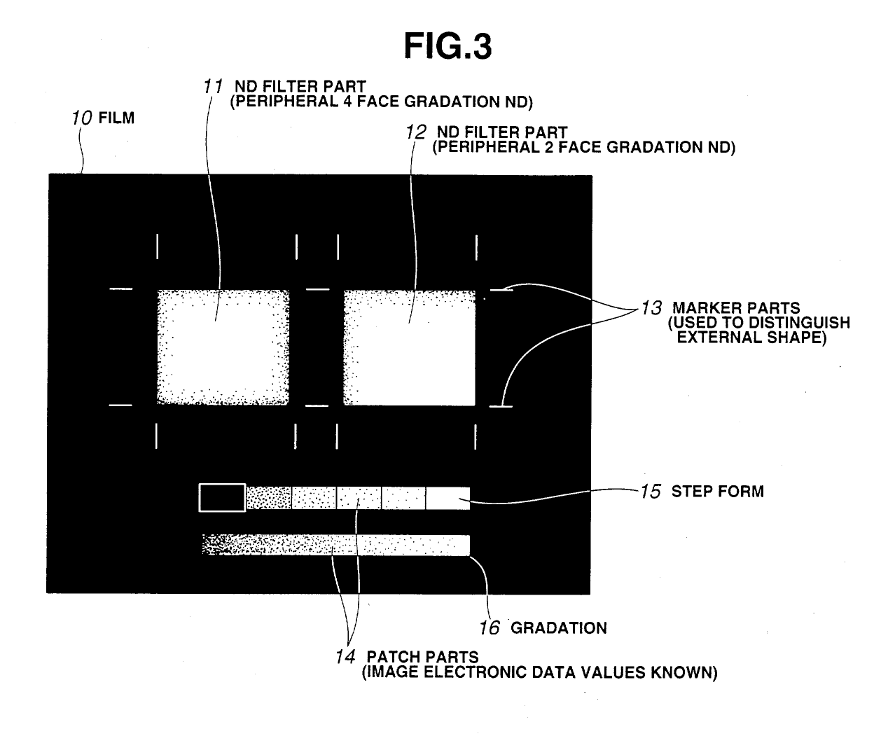

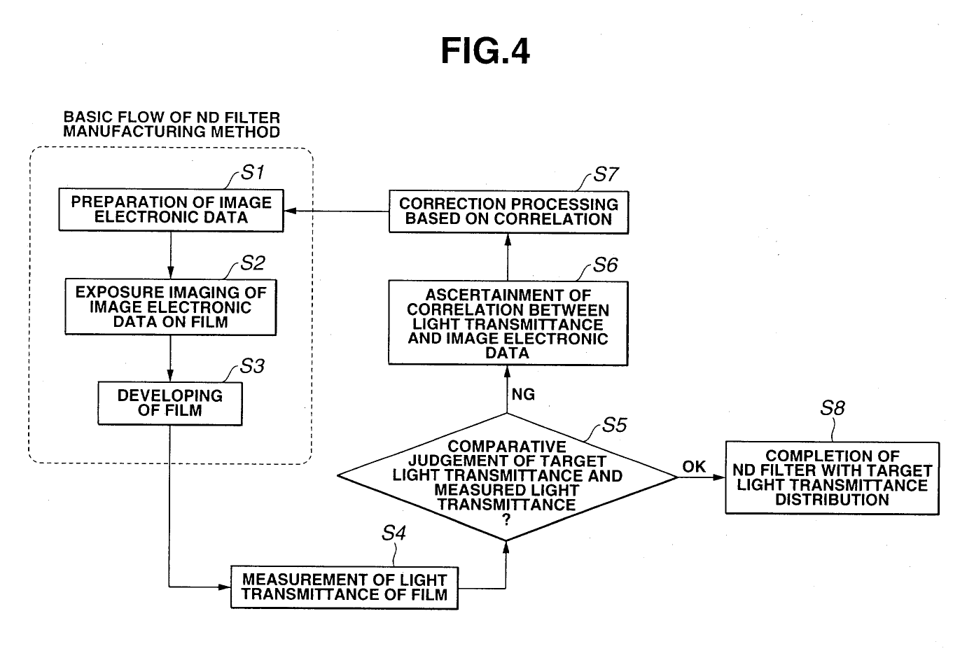

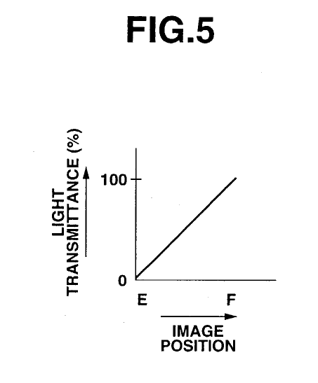

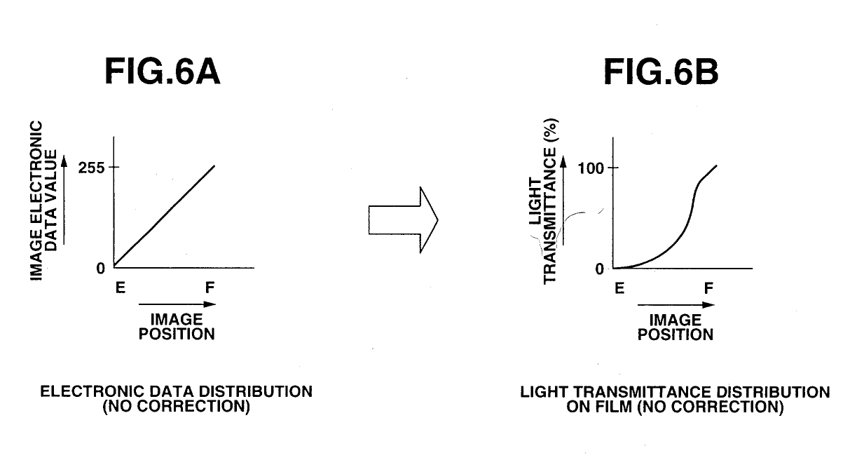

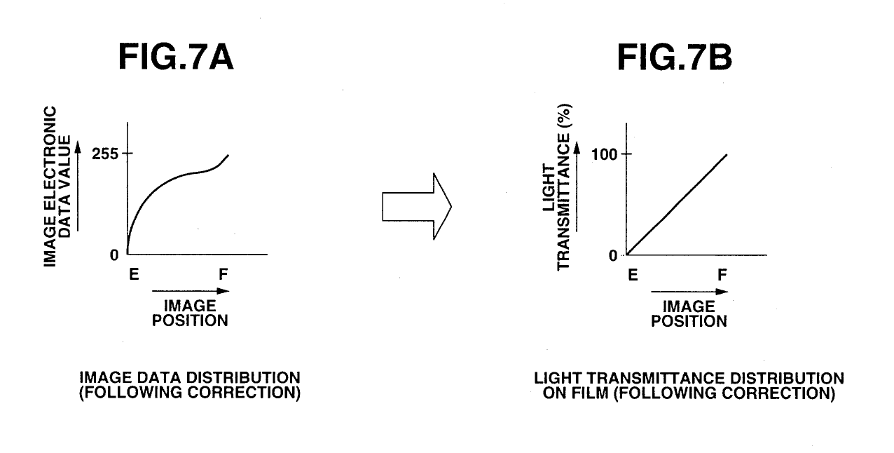

FIGS. 1 through 7B illustrate a first embodiment of the present invention, FIG. 1 is a diagram showing an example of the manufacture of ND filter constituent part by means of image electronic data which has light transmittance information for respective positions used to construct an ND filter, FIG. 2 is a graph which shows the numerical values constituting image electronic data on a line passing through A, B, C and D in FIG. 1, FIG. 3 is a diagram showing an example of manufacture in which a plurality of ND filter constituent parts based on image electronic data prepared in FIG. 1 are formed on a film, FIG. 4 is a flow chart which shows the processes from the preparation of the image electronic data to the completion of the filter manufacturing, FIG. 5 is a graph which shows the target light transmittance on the film, and FIGS. 6A, 6B, 7A and 7B are graphs which illustrate the electronic data correction method used to obtain the target light transmittance.

This ND filter manufacturing method first includes the step of preparing image electronic data for ND filter constituent part of the type shown in FIG. 1. In the image electronic data shown in FIG. 1, a gradation is formed in the left and right parts of the image. In order to simplify the description, this image electronic data may be described as follows in terms of a line passing through A, B, C and D. Part A is black (light transmittance 0%), part B is white (light transmittance 100%), and a smooth gradation is formed between A and B. Furthermore, the area from part B to part C is white (light transmittance 100%), part C is white (light transmittance 100%), part D is black (light transmittance 0%), and a smooth gradation is also formed between C and D. Such a data distribution in the left-right direction is constructed such that this distribution is uniform in the vertical direction.

Furthermore, exposure imaging is performed on a film consisting of a photosensitive material by means of a device (described later) that is capable of direct exposure imaging of image electronic data used to form ND filter constituent part, and an ND filter constituting a photosensitive filter is completed by subjecting this film to a development processing.

Thus, a film which has light transmittance information at respective positions used to form an ND filter can be obtained by exposing and imaging image electronic data on a film constituting a photosensitive material, and then developing this film.

FIG. 2 is a graph which shows the numerical values constituting image electronic data on a line passing through A, B, C and D in FIG. 1.

Ordinarily, values which express the numerical values of the respective colors R, G and B as gradations from 0 to 255 (8 bits) are generally known as image electronic data values. The RGB image electronic data value of 0 is black, and the value of 255 is white. In the case of an ND filter, since expression in black and white is possible, the same values are used for the numerical values of the respective colors R, G and B. However, in cases where a color film is used as the film that is the object of exposure, the R, G and B image electronic data values may be set at different settings in order to correct the coloring by adjusting the balance of the respective colors R, G and B.

FIG. 1 shows image electronic data corresponding to a single product. However, as is shown in FIG. 3, the preparation of a film that has a plurality of sets of image electronic data used to form ND filter constituent part of the type shown in FIG. 1 makes it possible to produce numerous products by a process in which a single film is treated.

In the example of ND filter constituent parts based on image electronic data of the type shown in FIG. 3, a plurality of ND filter parts 11 and 12 which have different shapes as ND filter constituent parts are formed on the surface of a film 10 constituting a photosensitive material. Specifically, the ND filter part 11 indicates a peripheral four face gradation ND filter constituent part, and the ND filter part 12 indicates a peripheral two side gradation ND filter constituent part. Furthermore, it would also of course be possible to form a plurality of ND filter constituent parts that have the shame shape.

Furthermore, it is necessary to cut out the ND filter constituent parts from the film 10 shown in FIG. 3 in an after-process. In this case, it is advisable to set marker parts 13 that make it possible to distinguish the external shapes of the ND filter constituent parts beforehand in accordance with the image electronic data. As a result, the precision of the cutting process can be more easily maintained, and the work is also facilitated, so that the external shape of the product can easily be cut out with high precision.

In FIG. 3, the image electronic data is prepared such that the image electronic data values of the portions other than the ND filter constituent parts are 0 (black). Furthermore, as will be described later, patch parts 14 used for light transmittance measurement which are formed by known image electronic data are further provided in order to facilitate measurement of the light transmittance distribution. In this example, the patch parts 14 include a step-form patch part 15 which has a plurality of gradations in steps, and a gradation patch part 16 with a continuously varying gradation.

FIG. 4 is a flow chart which shows the process from the preparation of the image electronic data to the completion of the filter manufacturing.

In the ND filter manufacturing method shown in this FIG. 4, the basic parts of the flow are parts in which image electronic data of the type shown in FIG. 1 or FIG. 3 is prepared (step S1), exposure imaging on a film constituting a photosensitive material is performed using a device that is capable of direct exposure imaging of this data on a photosensitive material (step S2), and the film thus obtained is formed into an ND filter by developing this film (step S3).

However, in the case of an ND filter manufactured using only the basic flow in such an ND filter manufacturing method, a light transmittance distribution that corresponds to the image electronic data prepared beforehand is in actuality only rarely obtained, because of differences in the photosensitive characteristics of the film and differences in the characteristics of the exposure imaging apparatus.

Accordingly, in a film manufactured by the basic flow of such an ND filter manufacturing method, the light transmittance of a portion of the film that has a known image electronic data value is measured (step S4), and a judgement is made as to whether or not this light transmittance measurement result is within the permissible range of the target transmittance (step S5). Here, in cases where the measurement result is within the permissible range, the product is judged to be OK, and the ND filter is completed (step S8). On the other hand, in cases where the measurement value is not within the permissible range, the product is judged to be no good, and the correlation between the light transmittance and image electronic data is derived (step S6). Then, image electronic data is prepared by performing correction processing on the image electronic data on the basis of this correlation (step S7), and exposure imaging is performed on a new film using this corrected image electronic data, after which this film is subjected to a development processing. Next, the light transmittance of the film thus manufactured is measured, and a check is made to ascertain whether or not this light transmittance is within the permissible range. Such a cycle is repeated until the results are found to be OK. If the width of the permissible value is set at a small width, an ND filter with higher precision can be obtained by repeating this cycle.

In the working of such an ND filter manufacturing method, there is a certain item that must be considered when the image electronic data is prepared. This item that must be considered is the resolution of the exposure imaging apparatus used in the after-process.

Examples of apparatus that can perform direct exposure imaging of the abovementioned image electronic data include an apparatus known as a laser imager which depicts images on the surface of a photosensitive material by scanning with a laser, and an apparatus known as a digital film recorder which performs exposure imaging by illuminating a CRT image on the surface of a photosensitive material.

For example, let us assume that the imaging resolution of the abovementioned laser imager is 2000 dpi (dots per inch). In order to form an image that is 100 mm² (10 mm×10 mm) on the film, it is sufficient to form an image of 787 (10×2000/25.4) dots×787 dots. Furthermore, means in which the image electronic data is displayed on a separate CRT, LCD or the like, and this display is exposed as a mask, may be used as means for the direct exposure imaging of image electronic data.

Thus, in the abovementioned ND filter manufacturing method, image electronic data which has the target light transmittance distribution is prepared, exposure imaging is performed on a film consisting of a photosensitive material by means of an exposure imaging device such as a laser imager, digital film recorder or the like on the basis of this data, and the film obtained by subjecting this film to a development processing is used “as is” as an ND filter.

If this manufacturing method is used, there is no need for the physical preparation of an original plate, so that an ND filter can be realized at low cost and in a short period of time. Furthermore, alteration and correction of the light transmittance distribution can easily be handled by preparing image electronic data. Accordingly, ND filters with patterns that have an extremely high degree of freedom in terms of the manufacturing process can be manufactured.

Furthermore, in this embodiment, exposure imaging by means of the laser imager is performed at an equal magnification for the sake of simplicity. However, it would also be possible to use a laser imager equipped with an optical system that varies the magnification. In this case, a more precise ND filter can be obtained by preparing image electronic data with a certain degree of magnification beforehand.

Furthermore, as a result of experimentation, the present applicant distilled that a film with a higher black optical density and a higher degree of white transparency can be obtained by processing exposure imaging and developing of image electronic data on a positive film by means of an exposure imaging apparatus, developing this positive film, and further converting the film into a negative film by a reversal processing. In other words, in a negative film prepared in this manner, the optical density of the portions that block light completely is high, and the transmittance of the portions that transmit light is high, so that a film with a high contrast is obtained.

Furthermore, films that may be used include various types of films such as color films, monochromatic films, negative films, positive films and the like, and these films have respectively different characteristics. When such films are used as an ND filter that has a light transmittance distribution, special attention must be paid to spectral characteristics, high resolution and resistance to color fading.

In regard to spectral characteristics, it is desirable that the film have a constant light transmittance in the wavelength region of 400 nm to 700 nm. Furthermore, the reason that it is desirable for the film to have a high resolution is as follows: namely, especially in cases where electronic image data in which the light transmittance distribution is a fluctuating distribution, gradations in the fluctuating parts cannot be smoothly realized if the resolution is low (i. e., silver halide particles of the film are coarse). Furthermore, having resistance to color fading means that the light transmittance during film preparation does not vary because of environmental factors such as light, heat or the like, or due to the passage of time. It is desirable that the film possess such resistance to color fading.

Taking such cautionary factors into account, a micro-copying film, which is one type of monochromatic film, (ACROS (manufactured by Fuji Shashin Film K.K.) may be cited as a concrete commercial name of such a film) is suitable for use as an ND filter. The reason for this is that micro-copying film is used for the duplication of documents, and can be finished with a more uniform optical density than is possible in the case of ordinary photographic films. By using such a micro-copying film, it is possible to produce a high-precision pattern, and to obtain an ND filter that is resistant to color fading.

Furthermore, in cases where an environment which is such that a large quantity of light is filtered is envisioned as the use environment of the ND filter, it is appropriate to use PET (polyethylene terephthalate), which is superior in terms of heat resistance, as the material of the film. Moreover, in cases where the light that constitutes the object of use of the ND filter is polarized light, it is appropriate to use TAC (triacetylcellulose), which does not perturb polarized light, as the material of the film. Thus, it is advisable that a film of one of the abovementioned materials be appropriately selected and used in accordance with the use environment of the ND filter.

Next, the details of the correction processing in step S7 of the abovementioned FIG. 4 will be described with reference to FIGS. 5 through 7B.

As is shown in FIG. 5, it is assumed that the target light transmittance distribution is a distribution that varies linearly from a light transmittance of 0% to a light transmittance of 100% with respect to part E through part F of the image position on the film.

In this case, image electronic data that varies linearly from 0 to 255 with respect to part E through part F of the image position is first given as shown in FIG. 6A. On the basis of this image electronic data, the film is subjected to exposure imaging and development processing in accordance with the basic flow of the abovementioned ND filter manufacturing method, and the light transmittance of the film is measured. It is assumed that the light transmittance distribution of the manufactured film that is obtained as a result is, for example, a distribution of the type shown in FIG. 6B. Furthermore, it is desirable that the number of measurement points used when this light transmittance distribution is obtained be as large as possible, and it is advisable that the number of measurement points be determined while taking into account the degree of precision required for the light transmittance.

Next, on the basis of the results shown in the abovementioned FIG. 6B, the relationship between the image electronic data and the light transmittance is converted into a numerical formula. Furthermore, the inverse function of this numerical formula is determined. The image electronic data prepared on the basis of the inverse function thus determined is data of the type shown in FIG. 7A. If a film is manufactured on the basis of this image electronic data using the basic flow of the abovementioned ND filter manufacturing method, a film that shows a high degree of agreement with the target light transmittance distribution shown in FIG. 7B can be obtained. In the present embodiment, furthermore, a polynomial approximation is used (as one example) in order to accomplish the abovementioned conversion into a numerical formula. In this case, the number of terms is increased so that there is no discrepancy between the numerical formula and the measured values.

As was described above, this correction processing is not limited to a single pass; a much greater increase in precision may be obtained by repeating this processing several times.

Furthermore, as is described above, it is desirable to provide patch parts used to measure the light transmittance, which are formed using known image electronic data (as shown in FIG. 3), in order to facilitate the measurement of the light transmittance distribution. As is shown in FIG. 3, these patch parts consist of a step-form patch part 15 which is formed such that this patch part has a plurality of gradations in steps, and a gradation patch part 16 which is formed such that this patch part has a continuously changing gradation. By reflecting numerous light transmittance measurement results with respect to the gradations of these patch parts 14 as described above, it is possible to improve the precision in the correction processing. Furthermore, evaluation of the suitability of the product can easily be accomplished by performing light transmittance measurements in the patch parts 14.

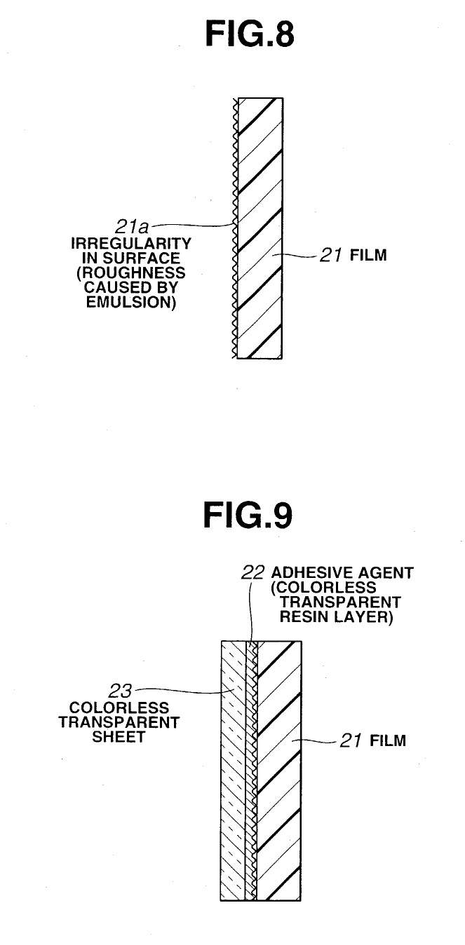

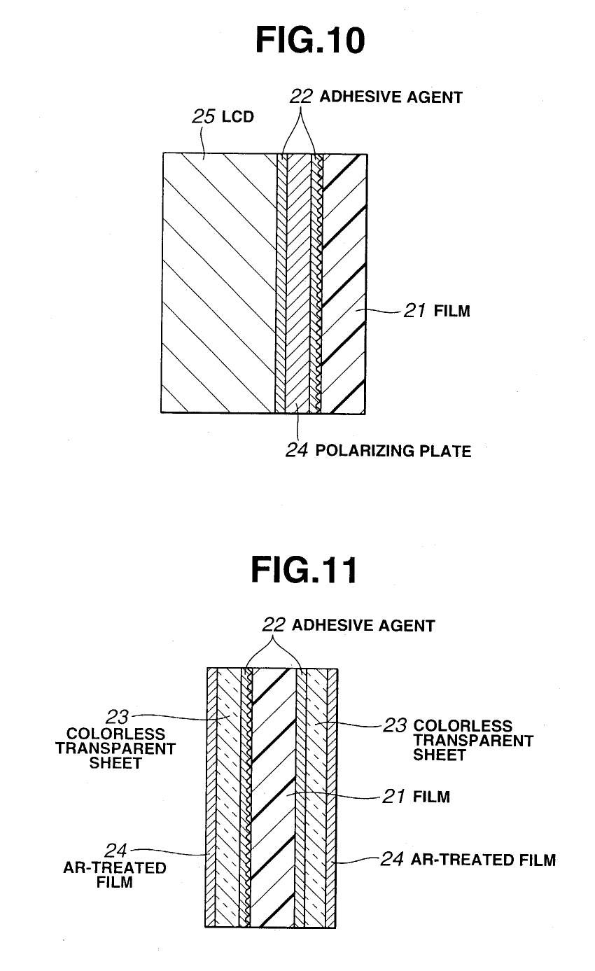

FIGS. 8 through 11 illustrate a second embodiment of the present invention. FIG. 8 is an enlarged sectional view which shows the film, FIG. 9 is an enlarged sectional view which shows the film in a state in which a colorless transparent sheet has been bonded to the film, FIG. 10 is an enlarged sectional view which shows the film in a state in which the film has been bonded to a polarizing plate on a liquid crystal panel (hereafter referred to as an “LCD”), and FIG. 11 is an enlarged sectional view which shows the film in a state in which anti-reflection-treated (hereafter “AR-treated”) colorless transparent sheets have been bonded to the film.

In the ND filter of this second embodiment, fine irregularity 21a with a size of 1 μm or less is present on the emulsion-coated surface of the film 21 that constitutes the photosensitive material (as show in FIG. 8). Since this surface irregularity 21a causes the diffusion of light in transparent portions as well, such irregularity leads to the generation of light that is unnecessary in optical terms, and to a drop in the brightness. Accordingly, as is shown in FIG. 9, a colorless transparent resin layer which has a thickness that can smoothly fill this irregularity in the emulsion, i. e., a thickness is equal to or greater than the depth extending from the peaks of the projections to the bottoms of the indentations, is formed so that the surface irregularity is eliminated, thus making it possible to obtain an ND filter that is a clear film. In other words, the generation of scattered light by the fine irregularity in the emulsion can be prevented by forming a colorless transparent resin layer 22 with a thickness that is sufficient to fill the irregularity.

In actuality, it is effective if a resin layer with a thickness of 1 μm or greater can be formed; however, in the example shown in FIG. 9, such a layer is constructed by laminating a colorless transparent resin layer 22 with a thickness of, for example, 25 μm constructed from an adhesive agent, and a colorless transparent sheet with a thickness of, for example, 100 μm (the material of this sheet is TAC (triacetylcellulose).

A colorless transparent sheet 23 on which a colorless transparent resin layer 22 is thus formed by coating with an adhesive agent is advantageous in that such a sheet is generally easy to obtain, and in that a colorless transparent resin layer (adhesive agent) can easily be formed on the surface of the film 21. Furthermore, it is desirable that this colorless transparent resin layer 22 be formed from a material which has a refractive index (n) comparable to that of the film 21. Moreover, it is not absolutely necessary to use a colorless transparent sheet 23; it may of course also be possible to form only a colorless transparent resin layer 22.

Furthermore, FIG. 10 shows one example of the construction of the abovementioned ND filter.

A polarizing plate 24 is bonded beforehand to an LCD 25 (which is a display element) using the adhesive agent 22. Furthermore, the side of the film of the ND filter 21 on which the irregularity of the emulsion is present is pasted to the abovementioned polarizing plate 24 by means of the adhesive agent 22 so that the irregularity is covered. As is described above, this adhesive agent 22 constitutes a colorless transparent resin layer.

Thus, unnecessary light is reduced by the installation of a colorless transparent resin layer; however, since the refractive index of the film and colorless transparent resin layer is around n=1.5, and the reflectivity in the visible light region is ordinarily 4 to 5%, it is conceivable that this may cause a deterioration in the light transmittance of the whole transmissive part.

Accordingly, if a colorless transparent sheet is used in which an AR(anti-reflection)-treated film 24 is disposed on one surface and an adhesive agent 22 consisting of a colorless transparent resin layer is disposed on the other surface (as shown in FIG. 11), the reflectivity in the visible light region can be suppressed to 1% or less by this AR-treated film 24. By pasting such an AR-treated colorless transparent sheet to both sides of the film 21, it is possible to increase the light transmittance by approximately 8% (approximately 4% on each side).

Furthermore, in the example shown in FIG. 11, an AR treatment is performed on both sides, and this construction is desirable in terms of optical performance; however, from the standpoint of manufacturing yield and increased cost due to the increased number of processes involved, it would also be possible to perform an AR treatment on one side only. Particularly in cases where such a treatment is performed on one side only, it would also be possible to form an AR treated film 24 directly on the surface of the film 21, namely, the other side surface of the surface with irregularity caused by the emulsion (although this is not shown in the figures).

Furthermore, because of the nature of the ND filter, it is desirable that such AR treatments have flat spectral characteristics in which the fluctuation width is 1% or less in the wavelength range of 400 nm to 700 nm.

Moreover, in cases where surface reflection has an undesirable effect on the use of the film as an ND filter, the areas corresponding to the AR-treated films 24 in FIG. 11 may be formed by anti-glare-treated (hereafter “AG-treated”) films.

By thus performing an AR treatment on the surface of the colorless transparent sheet 23 (constituting the colorless transparent sheet member) located on the other side surface of the surface on which the colorless transparent resin layer is formed, it is possible to increase the transmittance in the whole transmissive part. In the meantime, by performing an AG treatment instead of an AR treatment, it is possible to obtain an effect that prevents glare caused by reflected light.

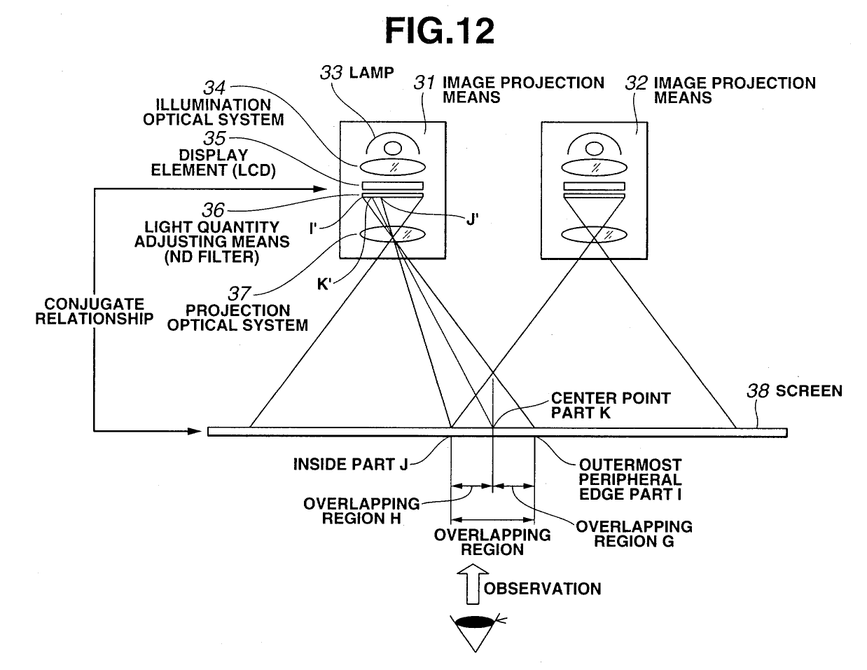

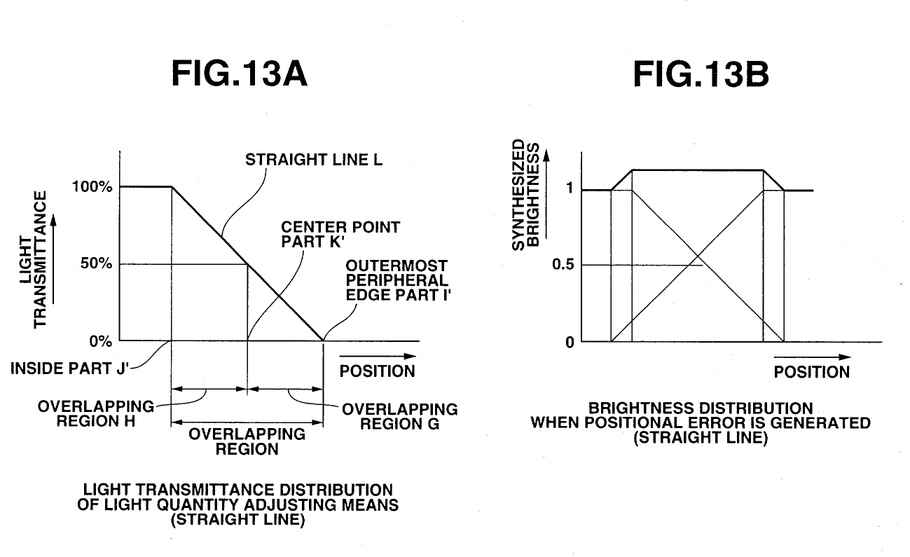

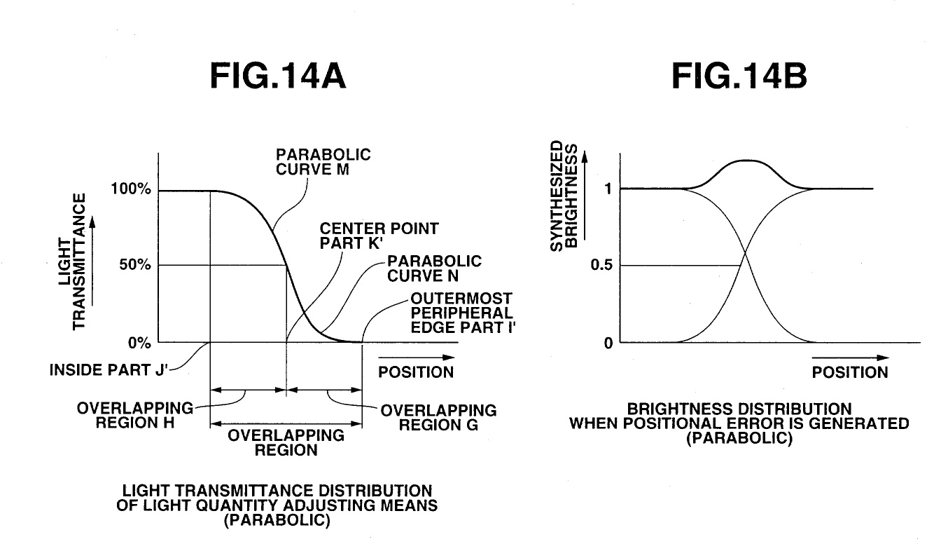

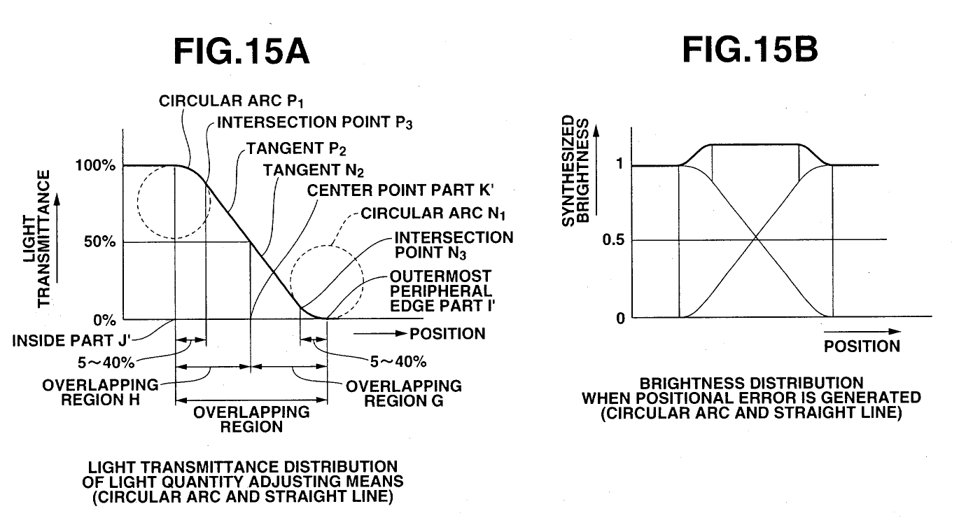

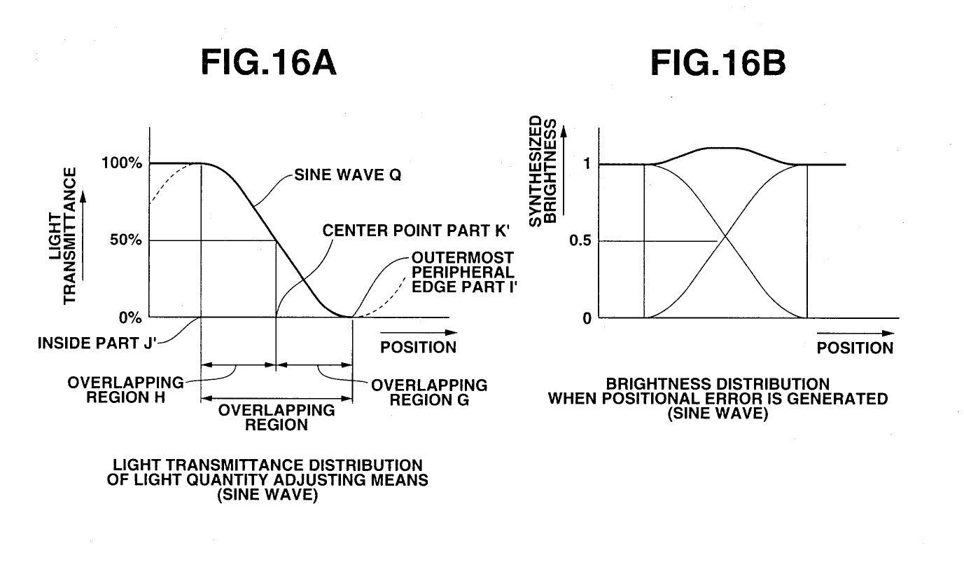

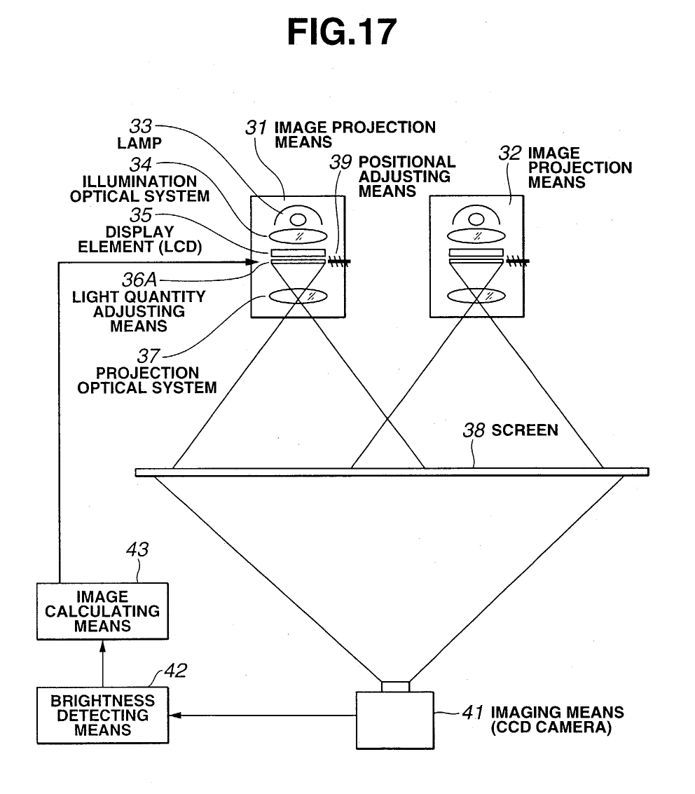

FIGS. 12 through 17 illustrate a third embodiment of the present invention. FIG. 12 is a diagram which shows the overall construction of a multi-display device, FIGS. 13A and 13B are graphs which show how the light quantity adjusting means of the multi-display device in FIG. 12 is constructed such that there is a rectilinear light transmittance distribution, and which also show the brightness distributions of the corresponding overlapping regions, FIGS. 14A and 14B are graphs which show how the light quantity adjusting means of the multi-display device in FIG. 12 is constructed such that there is a parabolic light transmittance distribution, and which also show the brightness distributions of the corresponding overlapping regions, FIGS. 15A and 15B are graphs which show how the light quantity adjusting means of the multi-display device in FIG. 12 is constructed such that there is a light transmittance distribution consisting of a circular arc and a tangent, and which also show the brightness distributions of the corresponding overlapping regions, FIGS. 16A and 16B are graphs which show how the light quantity adjusting means of the multi-display device in FIG. 12 is constructed such that there is a sine-waveform light transmittance distribution, and which also show the brightness distributions of the corresponding overlapping regions, and FIG. 17 is a diagram which shows a system for optimizing the light quantity adjusting means in the multi-display device.

As is shown in FIG. 12, the multi-display device of this third embodiment has image projection units (projectors) 31 and 32 used as image forming devices, each of which contains at least a lamp 33 that acts as a light source, a display element 35 such as an LCD or the like that is used to display images, and a projection optical system 37 which is used to enlarge and project an image of the display element 35. When partial images are projected onto a screen 38 by these respective image projection units, adjacent partial images are projected so that these partial images overlap with each other in the peripheral edge portions and form overlapping regions, and a single image is constructed by combining this plurality of partial images. Furthermore, in the example shown in FIG. 12, an illumination optical system 34 which is used to improve the illumination efficiency and insure that there is no irregularity in illumination is disposed between the light source 33 and the display element 35; however, this illumination optical system 34 is not essential, and may be omitted from the construction.

Moreover, a light quantity adjusting means 36 used to reduce the quantity of light are disposed in the vicinity of the display element 35 which is in a conjugate relationship with the screen 38, so that the brightness is not increased as a result of the overlapping of light in the abovementioned overlapping regions. As a result of such a disposition, the screen 38 and light quantity adjusting means 36 are also in a substantially conjugate relationship. The light quantity adjusting means 36 is disposed in the light path of the light beam that reaches the overlapping regions, and vary the quantity of light that passes through (transmittance), so that the brightness in the overlapping regions and the brightness in the non-overlapping regions are more or less the same.

Furthermore, in FIG. 12, an example is shown in which two image projection units are installed. However, the present invention is of course not limited to such a configuration; more than two image projection units may be installed. Moreover, in FIG. 12, a rear projection type multi-display device of the type in which images projected onto the screen 38 are observed from the opposite side of the image projection units 31 and 32 is shown. However, the present invention is not limited to such a configuration; the construction of the present embodiment could also be applied in a more or less similar manner even in the case of a front projection type multi-display device in which the images are observed from the same side as the image projection units.

Next, the light quantity adjustment of the light quantity adjusting means will be described.

The outermost peripheral edge portion of the overlapping region projected onto the screen 38 by the image projection unit 31 is designated as I, the inside portion of the overlapping region is designated as J, and the center point between I and J is designated as K. In this case, as is described above, the screen 38 and the light quantity adjusting means 36 are in a substantially conjugate relationship, and the points on the light quantity adjusting means 36 that correspond to the abovementioned I, J and K are designated as I′, J′ and K′. In a case where the quantity of light is to be reduced in the overlapping regions I through K on the screen 38 by the light quantity adjusting means 36 of the image projection unit 31, it is sufficient to reduce the quantity of light in the abovementioned regions I′ through K′ on the light quantity adjusting means 36.

Accordingly, in cases where it is desired to set the brightness in the overlapping regions of the multi-display device such that this brightness is more or less the same as the brightness in the non-overlapping regions, this can be realized by setting the light transmittance of the light quantity adjusting means 36 at 0% in the outermost peripheral edge portion of the overlapping region I′, setting the light transmittance at 100% in the inside portion J′, and maintaining a light transmittance distribution expressed by a straight line that connects these two points (as shown in FIG. 13A). In this case, the light quantity adjusting means 36 of the other image projection unit 32 that forms an overlapping region is also naturally set such that these other light quantity adjusting means 36 has the same light transmittance distribution.

When the light quantity adjusting means 36 is installed, it is often the case that such device is installed with a positional error occurring with respect to the target position. As a result, a positional deviation is generated in the light quantity adjustment of the light quantity adjusting means 36 with respect to the overlapping regions. In cases where the light quantity adjusting means 36 has a rectilinear light transmittance distribution as shown in the abovementioned FIG. 13A, such positional deviation results in a trapezoidal brightness variation of the type shown in FIG. 13B. FIG. 13B shows the conditions in the vicinity of the overlapping region in a state in which the position of the light quantity adjusting means 36 is displaced toward the outside of the image; here, the brightness rises in a trapezoidal pattern. Conversely, in cases where the position of the light quantity adjusting means 36 is displaced toward the inside of the image, the brightness in the vicinity of the overlapping region drops in a trapezoidal pattern.

The present applicant has discovered by experimentation that the trapezoidal brightness variation of this type that occurs when the light quantity adjusting means is erroneously disposed is seen by the human eye as a band-shaped area in which the brightness differs from that of the non-overlapping regions. Furthermore, the present applicant has discovered by experimentation that if the edges at the sharp turning points in the brightness variation curve shown in FIG. 13B are removed so that the curve is rounded, it becomes hard for these areas to be seen as band-shaped areas by the human eye.

FIGS. 14A through 14B shows examples of light transmittance distributions of the light quantity adjusting means 36 that has been devised from this standpoint such that no abrupt variation in brightness occurs even in cases where there is an error in the disposition of the light quantity adjusting means 36.

First, FIG. 14A shows an example in which the light transmittance distribution of the light quantity adjusting means 36 is constructed from parabolic curves.

In this light quantity adjusting means 36, the light transmittance values at respective points are 0% in the outermost peripheral edge part I′, 50% in the center point part K′, and 100% in the inside part J′. In this light transmittance distribution, the overlapping region G between the outermost peripheral edge part I′ and the center point part K′ shows a parabola N which protrudes downward, passing through the 50% value of the center point part K′ with the 0% value of the abovementioned outermost peripheral edge part I′ as the apex, while the overlapping region H between the inside part K′ and the center point part K′ shows a parabola M which protrudes upward, passing through the 50% value of the center point part K′ with the 100% value of the abovementioned inside part J′ as the apex.

In the light quantity adjusting means 36 which has such a parabolic light transmittance distribution, the brightness distribution that is seen in a case where error occurs in the disposition of the light quantity adjusting means 36 is (for example) as shown in FIG. 14B. In this case, the brightness variation is such that the base and apex parts have a rounded peak-form shape, so that (in particular) the sharp corners in the trapezoidal brightness variation curve shown in the abovementioned FIG. 13B can be eliminated. As result, there is no abrupt variation in the slope of the brightness, so that the overlapping regions can be made hard to be distinguished as overlapping regions (as was described above).

FIG. 15A shows an example in which the light transmittance distribution of the light quantity adjusting means 36 is formed with circular arcs and tangents of these circular arcs.

As in the example shown in the abovementioned FIG. 14A, the light transmittance values at respective points in the light quantity adjusting means 36 are 0% in the outermost peripheral edge part I′, 50% in the center point part K′, and 100% in the inside part J′.

Furthermore, in the light quantity adjusting means 36 shown in this FIG. 15A, the overlapping region G has a light transmittance distribution in which a circular arc N₁ which has the light transmittance of 0% in the outermost peripheral edge part I′ as its apex is connected to one end of a tangent N₂ of the abovementioned circular arc N₁, the other end of which is connected to a point of the light transmittance of 50% of the center point part K′, and the overlapping region H has a light transmittance distribution in which a circular arc P₁ which has the light transmittance of 100% in the inside part J′ as its apex is connected to one end of a tangent P₂ of the abovementioned circular arc P₁, the other end of which is connected to a point of the light transmittance of 50% of the center point part K′. The diameter of the abovementioned circular arc N₁ and the diameter of the circular arc P₁ are the same, and the abovementioned tangent N₂ and tangent P₂ are line segments on the same straight line (in other words, a straight line containing the tangent N₂ and tangent P₂ forms a common tangent of the circular arc N₁ and circular arc P₁).

Furthermore, the distance from the intersected point N₃ of the circular arc N₁ and the tangent N₂ to the outermost peripheral edge part I′ is desirable 5 to 40% of the overlapping region G; similarly, in regard to the intersected point P₃ formed by the circular arc P₁ and the tangent P₂, the distance from the inside part J′ to the intersected point P₃ is desirable 5 to 40% of the overlapping region H.

In the light quantity adjusting means 36 which has a light transmittance distribution consisting of such circular arcs and tangents, the brightness distribution that is seen in cases where an error occurs in the disposition of the light quantity adjusting means 36 is (for example) as shown in FIG. 15B. In this case, the variation in brightness shows a smooth trapezoidal pattern in which the corner portions of the trapezoidal shape shown in the abovementioned FIG. 13B are rounded. As a result, there is no abrupt variation in the slope of the brightness, so that the overlapping regions can be made hard to be distinguished as overlapping regions (as was described above).

FIG. 16A shows an example in which the light transmittance distribution of the light quantity adjusting means 36 is a distribution that is constructed from a sine wave.

As in the examples shown in the abovementioned FIGS. 14A and 15A, the light transmittance values at respective points in the light quantity adjusting means 36 are 0% in the outermost peripheral edge part I′, 50% in the center point part K′, and 100% in the inside part J′.

If a sine wave which has a period that is twice of the overlapping region, and which vibrates with an amplitude of 50% between 0% and 100% in the light transmittance is designated as the sine wave Q, then, in the light quantity adjusting means 36 shown in FIG. 16A, a light transmittance distribution in which the sine wave Q is caused to fit such that the inside part J′ corresponds to a position of 90°, the center point part K′ corresponds to a position of 180°, and outermost peripheral edge part I′ corresponds to a position of 270°, is the light transmittance distribution in the overlapping region.

In the light quantity adjusting means 36 which has such a sine-waveform light transmittance distribution, the brightness distribution in cases where an error occurs in the disposition of the light quantity adjusting means 36 is (for example) as shown in FIG. 16B. In this case, the peak value of the brightness generated by this error is small compared to the case of the parabolic shape shown in the abovementioned FIG. 13B.

By thus constructing the brightness distribution of the overlapping region as a curve of the type shown in the abovementioned FIG. 14A, 15A or 16A, it is possible to smooth the brightness distribution in cases where an error occurs in the disposition of the light quantity adjusting means, so that a plurality of partial images can easily be recognized as being identical in visual terms.

Furthermore, in FIG. 12, for the sake of simplicity, an example is illustrated in which a single overlapping region is constructed by respectively projecting partial images using two image projection units 31 and 32. However, the present invention may be similarly applied in cases where partial images are respectively projected by three or more image projection units such that there are two or more overlapping regions in order to obtain a higher-precision image or large-screen image.

In cases where two or more overlapping regions are thus constructed using three or more image projection units, it would also be possible to construct the system such that the light transmittance distribution of the light quantity adjusting means 36 is varied for each overlapping region.

As a concrete example, the dimensions of the image in common image projection units (projectors) differ in the longitudinal and lateral directions, with a longitudinal-lateral ratio of (for example) 4:3 or the like. In such a case, a smoother image can be obtained if the light transmittance distribution of the light quantity adjusting means 36 is varied between the overlapping regions in the longitudinal direction and the overlapping regions in the lateral direction. Thus, a finer light quantity adjustment can be accomplished by respectively setting the light transmittance distribution of the light quantity adjusting means 36 on two or more sides of the overlapping regions.

In a multi-display device, as is described above, it is difficult to dispose the light quantity adjusting means 36 with respect to the overlapping regions without any error. However, even in cases where such disposition error occurs, it is possible to devise the system such that any brightness distribution that might occur is hard to be detected by arranging the system such that the brightness distribution in the overlapping regions is a curve such as a parabola, circular arc, sine wave or the like.

Next, the system used to optimize the light quantity adjusting means in the multi-display device will be described with reference to FIG. 17.

This multi-display device adds the following units to the multi-display device shown in FIG. 12: an image pickup unit 41 consisting of a CCD camera or the like used to pick up the images that are projected onto the screen by the abovementioned image projection units 31 and 32; a brightness detecting means 42 which extracts a brightness signal from the image pickup signal of the abovementioned image pickup unit 41 and detect the shape and brightness of the overlapping regions; an image calculating unit 43 which performs calculations on the basis of the output of the abovementioned brightness detecting means 42 such that the quantity of light in the overlapping regions adjusted by the light quantity adjusting means 36A (described later) becomes optimal; and a positional adjuster 39 which is used to adjust the position of the light quantity adjusting means 36A (described later) relative to the display element consisting of an LCD or the like; and furthermore, instead of the light quantity adjusting means 36 in the abovementioned FIG. 12, light quantity adjusting means 36A which adjusts the quantity of light of the luminous flux that is projected onto the abovementioned overlapping regions so that the brightness of the abovementioned overlapping regions is caused to coincide substantially with the brightness of the partial images excluding these overlapping regions, and which adjust the light quantity on the basis of the results of the calculations performed by the abovementioned image calculating unit 43, are provided.

Next, the flow of the optimization system of the light quantity adjusting means 36A in the multi-display device will be described.

First, as is shown in FIG. 17, the image pickup unit 41 is disposed such that the images projected onto the screen 38 of the multi-display device can be picked up. It is desirable that the position in which the image pickup unit 41 is disposed in this case be a position which is such that the full image of the multi-display device be more or less completely picked up within the image pickup rate (image picking-up frame) of the image pickup unit 41; however, it is sufficient if the overlapping regions are included within the image pickup range. Furthermore, since the object of the image pickup unit 41 is to acquire the brightness distribution data and geometric shape, it is sufficient if the image pickup unit consists of a black and white camera rather than a color camera. In regard to the camera used as the image pickup unit 41, it is desirable that the γ characteristics or shading data of the image pickup lens, or both, be known.

Next, in a state in which the light quantity adjusting means 36A is not inserted into the light path, or a state in which the entire region is wholly transmissive, 100% white images are projected onto the screen 38 by the image projection units 31 and 32, and the projected images are picked up and input by the abovementioned image pickup unit 41.

Then, on the basis of the signal captured by the abovementioned image pickup unit 41, the geometric shape and brightness information of the overlapping regions are detected by the brightness detecting means 42.

On the basis of the information detected by the abovementioned brightness detecting means 42, the image calculating unit 43 calculates the optimal value of the light quantity adjusting means 36A, which is such that the brightness in the overlapping regions and the brightness of the partial images excluding these overlapping regions substantially coincide with each other.

Furthermore, as a result of the light quantity adjustment performed by the light quantity adjusting means 36A on the basis of the results of the calculations performed by the image calculating unit 43, the boundaries between the overlapping regions and the regions other than these overlapping regions become hard to be distinguished.

The light quantity adjusting means 36A used in this case preferably consists of (for example) an ND filter, and it is desirable that this ND filter be manufactured by the manufacturing method of the abovementioned first embodiment. In this case, an optimal ND filter can easily be manufactured by varying the image electronic data on the basis of the results calculated by the image calculating unit 43. Furthermore, in cases where light quantity adjusting means 36A constructed from the abovementioned ND filter is inserted into the image projection unit 31, disposition error may occur. In such a case, therefore, a fine adjustment of the position is performed using the abovementioned positional adjuster 39. Such a light quantity adjustment is performed for both the image projection unit 31 and the image projection unit 32.

Furthermore, as another example, the light quantity adjusting means 36A may be constructed from a liquid crystal that has one or more cells. In this case, only processing, which applies an electrical signal based on the results calculated by the image calculating unit 43 to the liquid crystal and displays this signal, is required; accordingly the adjustment of the light quantity is further simplified. Here, higher-precision modulation can be accomplished as the number of cells of the liquid crystal is increased. Furthermore, in cases where the light quantity adjusting means 36A is constructed from a liquid crystal, the abovementioned positional adjuster 39 may become unnecessary if the construction of the light quantity adjusting means 36A has a much greater size than that of the display element 35.

Thus, in a multi-display device of the type shown in FIG. 12, in which overlapping regions are present, it is extremely difficult to set the overlapping regions in a fixed manner because of manufacturing error and disposition error of the respective parts. However, if an optimizing system for the light quantity adjusting means in the multi-display device such as that shown in FIG. 17 is constructed, an adjustment can easily be made following the installation of the multi-display device by performing feedback using the image pickup unit, brightness detecting means and image calculating unit. Thus, by reflecting the calculated results, it is possible to achieve a more accurate light quantity adjustment, so that a higher-quality display device can be realized.

Furthermore, as another embodiment, it is also conceivable to use the abovementioned light quantity adjusting means in order to correct the irregularity in the brightness of the image projection units (projectors) as an image forming device.

In the image projection units, there is generally an in-plane irregularity in the brightness, wherein a brightness peak is present in the central portion of each image projection unit, and the brightness drops toward the peripheral parts. Accordingly, by utilizing light quantity adjusting means such as the abovementioned ND filter and adding light quantity adjusting means that has a transmittance distribution that is the opposite of the in-plane irregularity, it is possible to realize an image projection unit that has a uniform brightness distribution. The light quantity adjusting means in this case may be incorporated into a system which optimizes the light quantity using a feedback system constructed such that this system includes the image pickup unit, brightness detecting means and image calculating unit shown in the abovementioned FIG. 17.

Thus, the images that are projected onto the screen can be given a more uniform brightness distribution by forming the light transmittance distribution of the light quantity adjusting means such that irregularities in brightness caused by the light source or optical system of the image projection units cancel each other out.

Having described the preferred embodiments of the invention referring to the accompanying drawings, it should be understood that the present invention is not limited to those precise embodiments, and that various changes and modifications thereof could by made by one skilled in the art without departing from the spirit or scope of the invention as defined in the appended claims.

What is claimed is:

1. An ND filter manufacturing method comprising the steps of:
performing exposure imaging on a photosensitive material on the basis of light transmittance information for respective positions used to construct an ND filter; and
developing said photosensitive material.

2. The ND filter manufacturing method according to claim 1, wherein said photosensitive material is a positive film, and wherein said ND filter manufacturing method further comprises the step of further subjecting said developed positive film to a reversal-developing processing for converting same into a negative film.

3. The ND filter manufacturing method according to claim 1, further comprising the steps of:
measuring the light transmittance of the film manufactured on the basis of arbitrary light transmittance information;
determining the correlation between the measurement results for said light transmittance and said light transmittance information;
determining a correction value on the basis of the correlation thus determined; and
correcting said arbitrary light transmittance information on the basis of said correction value.

4. The ND filter manufacturing method according to claim 2, further comprising the steps of:
measuring the light transmittance of the film manufactured on the basis of arbitrary light transmittance information;
determining the correlation between the measurement results for said light transmittance and said light transmittance information;
determining a correction value on the basis of the correlation thus determined; and
correcting said arbitrary light transmittance information on the basis of said correction value.

5. The ND filter manufacturing method according to claim 1, wherein said step of performing exposure imaging includes the step of exposing a patch part, which has transmittance of a plurality of gradations following said development processing, on the same photosensitive material except the areas that constitute the ND filter on said photosensitive material.

6. The ND filter manufacturing method according to claim 5, wherein said patch part is exposed such that this patch part has band-shaped regions with a plurality of transmittance values following said development processing.

7. The ND filter manufacturing method according to claim 1, wherein said patch part is exposed such that the patch part has a region with gradational transmittance following said development processing.

8. The ND filter manufacturing method according to claim 1, wherein said step of performing exposure imaging includes the step of exposing marker parts, which make it possible to distinguish the limits of the external shape of the areas constituting the ND filter following said development processing, on the same photosensitive material except the areas that constitute the ND filter on said photosensitive material.

9. The ND filter manufacturing method according to claim 1, wherein said photosensitive material is a micro-copying film.

10. The ND filter manufacturing method according to claim 1, wherein said photosensitive material is a film, and the material of said film is PET (polyethylene terephthalate).

11. The ND filter manufacturing method according to claim 1, wherein said photosensitive material is a film, and the material of said film is TAC (triacetylcellulose).

12. An ND filter which is formed using a film that is subjected to a development processing, said film comprising:
a film layer in which the light transmittance differs according to the position; and
a colorless transparent resin film which has a thickness that makes it possible to fill small irregularity in the surface of said film layer.

13. The ND filter according to claim 1, wherein said colorless transparent resin layer is an adhesive agent layer.

14. The ND filter according to claim 13, wherein said adhesive agent layer is formed by a colorless transparent sheet member on which an adhesive agent is applied, and said colorless transparent sheet member is pasted to said developed film by the adhesive agent that is applied thereon.

15. The ND filter according to claim 14, wherein the reversed side of said colorless transparent sheet member, on which an adhesive agent is applied, is subjected to an anti-reflection (AR) or anti-glare (AG) treatment.

16. A multi-display device comprising:
a plurality of image projection units, wherein a single image is formed as a whole by arranging partial images projected onto a screen by said image projection units such that there are overlapping regions at the peripheral edges in adjacent partial images; and
a light quantity adjusting means which adjusts the light quantity of the luminous flux that is projected onto said overlapping regions with respect to one peripheral edge of each of said projected partial images so that the brightness of said overlapping regions is caused to coincide substantially with the brightness of the partial images in areas other than said overlapping regions, wherein the light transmittance is set such that the brightness distributions of said overlapping regions are formed by curves.

17. The multi-display device according to claim 16, wherein the light transmittance distribution of said light quantity adjusting means with respect to one peripheral edge of each of said projected partial images is formed by the track of a parabola.

18. The multi-display device according to claim 16, wherein the light transmittance distribution of said light quantity adjusting means with respect to one peripheral edge of each of said projected partial images is formed by a circular arc and a tangent of said circular arc, and said circular arc is formed in the most peripheral edge portions of said overlapping regions.

19. The multi-display device according to claim 16, wherein the light transmittance distribution of said light quantity adjusting means with respect to one peripheral edge of each of said projected partial images is formed by the track of a sine wave.

20. A multi-display device comprising:
three or more image projection units, wherein a single image is formed as a whole by arranging partial images projected onto a screen by said image projection units such that there are overlapping regions at the peripheral edges in adjacent partial images; and
a light quantity adjusting means which adjusts the light quantity of the luminous flux that is projected onto said overlapping regions with respect to one peripheral edge of each of said projected partial images so that the brightness of said overlapping regions is caused to coincide substantially with the brightness of the partial images in areas other than said overlapping regions, wherein there are overlapping regions on two or more sides, and there are two or more light transmittance distributions.

21. A multi-display device which comprises a plurality of image projection units, wherein a single image is formed as a whole by arranging partial images projected onto a screen by said image projection units so that there are overlapping regions at the peripheral edges in adjacent partial images, and wherein said multi-display device further comprises:
an image pickup unit for capturing the images projected onto said screen;
a brightness detection unit for detecting the shape and brightness of said overlapping regions by extracting brightness signals from the image pickup signals of said image pickup unit;
a light quantity adjusting means which adjusts the light quantity of the luminous flux that is projected onto said overlapping regions with respect to one peripheral edge of each of said projected partial images so that the brightness of said overlapping regions is caused to coincide substantially with the brightness of the partial images in areas other than said overlapping regions; and
an image calculating unit for performing calculations in order to adjust the light quantity to the optimal light quantity on the basis of the output of said brightness detection unit, and for controlling the light quantity adjustment of said light quantity adjusting means on the basis of the results of said calculations.

22. The multi-display device according to claim 21, wherein said light quantity adjustment unit consists of an ND filter.

23. The multi-display device according to claim 21, wherein said light quantity adjusting means consists of a liquid crystal constructed with one or more cells.

24. The multi-display device according to claim 16, wherein said image projection units each comprise:
a lamp which serves as a light source;
an image display element which forms an image;
a projection optical system which is used to enlarge and project the image of said image display element; and
a light quantity adjusting means which is manufactured by an ND filter manufacturing method comprising the steps of performing exposure imaging on a photosensitive material on the basis of light transmittance information for respective positions used to construct an ND filter, and developing said photosensitive material.

25. The multi-display device according to claim 20, wherein said image projection units each comprise:
a lamp which serves as a light source;
an image display element which forms an image;
a projection optical system which is used to enlarge and project the image of said image display element; and
a light quantity adjusting means which is manufactured by an ND filter manufacturing method comprising the steps of performing exposure imaging on a photosensitive material on the basis of light transmittance information for respective positions used to construct an ND filter, and developing said photosensitive material.

26. The multi-display device according to claim 21, wherein said image projection units each comprise:
a lamp which serves as a light source;
an image display element which forms an image;
a projection optical system which is used to enlarge and project the image of said image display element; and
a light quantity adjusting means which is manufactured by an ND filter manufacturing method comprising the steps of performing exposure imaging on a photosensitive material on the basis of light transmittance information for respective positions used to construct an ND filter, and developing said photosensitive material.

27. The multi-display device according to claim 16, wherein said image projection units each comprise:
a lamp which serves as a light source;
an image display element which forms an image;
a projection optical system which is used to enlarge and project the image of said image display element; and
a light quantity adjusting means constituted by an ND filter using a developed film that comprises a film layer in which the light transmittance differs in respective positions, and a colorless transparent resin layer which has a thickness that makes it possible to fill small irregularity in the surface of said film.

28. The multi-display device according to claim 20, wherein said image projection units each comprise:
a lamp which serves as a light source;
an image display element which forms an image;
a projection optical system which is used to enlarge and project the image of said image display element; and
a light quantity adjusting means constituted by an ND filter using a developed film that comprises a film layer in which the light transmittance differs in respective positions, and a colorless transparent resin layer which has a thickness that makes it possible to fill small irregularity in the surface of said film.

29. The multi-display device according to claim 21, wherein said image projection units each comprise:
a lamp which serves as a light source;
an image display element which forms an image;
a projection optical system which is used to enlarge and project the image of said image display element; and
a light quantity adjusting means constituted by an ND filter using a developed film that comprises a film layer in which the light transmittance differs in respective positions, and a colorless transparent resin layer which has a thickness that makes it possible to fill small irregularity in the surface of said film.

30. An image forming device comprising:
a lamp which serves as a light source;
an image display element which forms an image;
a projection optical system which is used to enlarge and project the image of said image display element; and
a light quantity adjusting means manufactured by the ND filter manufacturing method according to claim 1.

31. An image forming device comprising:
a lamp which serves as a light source;
an image display element which forms an image;
a projection optical system which is used to enlarge and project the image of said image display element; and
a light quantity adjusting means constituted by the ND filter according to claim 12.
